(19) United States
(12) Patent Application Publication
(10) Pub. No.: US 2018/0224126 A1
(43) Pub. Date: Aug. 9, 2018

(54) Stove Top BBQ

(71) Applicant: Anura Samaraweera, El Monte, CA (US)

(72) Inventor: Anura Samaraweera, El Monte, CA (US)

(21) Appl. No.: 15/885,082

(22) Filed: Jan. 31, 2018

Related U.S. Application Data
(60) Provisional application No. 62/455,591, filed on Feb. 7, 2017.

(51) Int. Cl. F24B 1/00; A47J 37/07; A47J 36/26; A47J 36/08

(52) U.S. Cl. CPC F24B 1/003; A47J 36/08; A47J 36/26; A47J 37/0704

(57) ABSTRACT

A stove top barbeque may be used with common stoves to provide grilled cooking results. The stove top barbeque includes a base, a lid, and a grate for supporting food. The base includes lower flutes for catching liquids, and inverted upper flutes above the lower flutes to guide the liquids into the lower flutes. The lower flutes are staggered upwards from the middle pair outwards to distribute to distribute the flame below more evenly. This configuration allows for direct flame-grilling of food placed on the grate. The upper and lower flutes have a gradual slope to carry liquids to a trough along the front of the stove top barbeque. The grate lifts off for cleaning. The lid has an open position and a closed position over the base and is removable by lifting from the base. A catch holds the lid open in a nearly vertical position to drain condensation.

### CROSS-REFERENCE TO RELATED APPLICATIONS

The present application claims the priority of U.S. Provisional Patent Application Ser. No. 62/455,591 filed Feb. 7, 2017, which application is incorporated in its entirety herein by reference.

### BACKGROUND OF THE INVENTION

The present invention relates to cooking and in particular to a grill positionable on a stove to barbeque food.

The flavor of barbequed food is widely enjoyed. Generally, barbequing is performed on an outdoor barbeque. Unfortunately, it is not always convenient to cook outdoors and there is a need for a barbeque grill which can be used with a common stove to obtain the results achieved using an outdoor barbeque. Known indoor grills do not allow flame-grilling.

### BRIEF SUMMARY OF THE INVENTION

The present invention addresses the above and other needs by providing a stove top barbeque which may be used with common stoves to provide grilled cooking results. The stove top barbeque includes a base, a lid, and a grate for supporting food. The base includes lower flutes for catching liquids, and inverted upper flutes above the lower flutes to guide the liquids into the lower flutes. The lower flutes are staggered upwards from the middle pair outwards to distribute to distribute the flame below more evenly. This configuration allows for direct flame-grilling of food placed on the grate. The upper and lower flutes have a gradual slope to carry liquids to a trough along the front of the stove top barbeque. The grate lifts off for cleaning. The lid has an open position and a closed position over the base and is removable by lifting from the base. A catch holds the lid open in a nearly vertical position to drain condensation.

In accordance with one aspect of the present invention, a set of lower flutes captures liquid dripping from a grate. A pair of inner flutes are lowest, a pair of intermediate flutes are outside and above the inner pair, and a pair of outer flutes are outside the intermediate flutes and higher than both the inner and the intermediate flutes. The staggered depths of the inner flutes improves the spreading of heat across the width of the barbeque.

### BRIEF DESCRIPTION OF THE SEVERAL VIEWS OF THE DRAWING

The above and other aspects, features and advantages of the present invention will be more apparent from the following more particular description thereof, presented in conjunction with the following drawings wherein:

FIG. 1 is an exploded view of a stove top barbeque according to the present invention

FIG. 2A is a front view of a base of the stove top barbeque according to the present invention.

FIG. 2B is a side view of the base of the stove top barbeque according to the present invention.

FIG. 2C is a top view of the base of the stove top barbeque according to the present invention.

FIG. 3 is a cross-sectional view of the base of the stove top barbeque according to the present invention, taken along line 3-3 of FIG. 2A.

FIG. 4 is a cross-sectional view of the base of the stove top barbeque according to the present invention, taken along line 4-4 of FIG. 2C.

FIG. 5 shows a lid portion of a catch according to the present invention.

FIG. 6 shows a base portion of the catch according to the present invention.

FIG. 7A shows the catch holding the lid open according to the present invention.

FIG. 7B shows the catch with the lid closed according to the present invention.

FIG. 8A shows a perspective view of the lid separated from the base of the stove top barbeque according to the present invention.

FIG. 8B shows a perspective view of the lid closed on the base of the stove top barbeque according to the present invention.

FIG. 8C shows a perspective view of the lid held open on the base of the stove top barbeque according to the present invention.

Corresponding reference characters indicate corresponding components throughout the several views of the drawings.

### DETAILED DESCRIPTION OF THE INVENTION

The following description is of the best mode presently contemplated for carrying out the invention. This description is not to be taken in a limiting sense, but is made merely for the purpose of describing one or more preferred embodiments of the invention. The scope of the invention should be determined with reference to the claims.

Where the terms “about” or “generally” are associated with an element of the invention, it is intended to describe a feature's appearance to the human eye or human perception, and not a precise measurement.

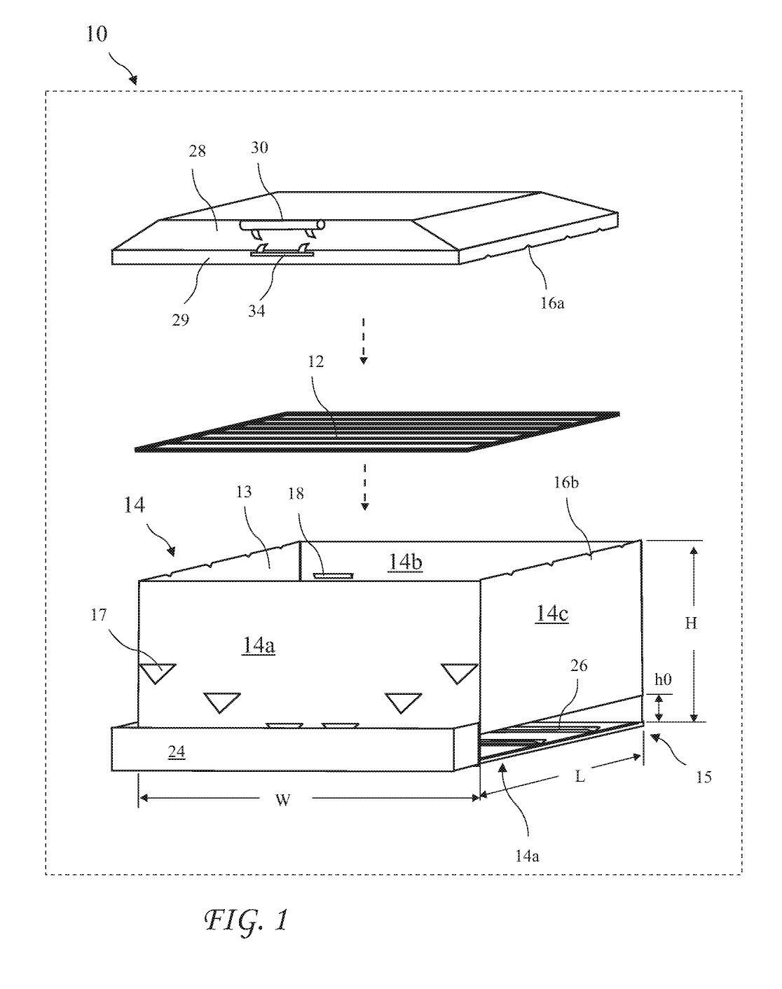

An exploded view of a stove top barbeque 10 according to the present invention is shown in FIG. 1. The stove top barbeque 10 includes a base 14, a grate 12, and a lid 28. The base 14 preferably includes a rectangular body 13 with a width W, a length L and height H. The Width W is preferably about 26 cm, the Length L is preferably about 26 cm, and the height H is preferably about 15 cm. The base 14 includes a trough 24 along the front 14a, and contains lower flutes 20 and inverted upper flutes 22 (see FIG. 4) above and overlapping the lower flutes 20. The inverted upper flutes 22 overlap the lower flutes 20 and deflect liquids into the lower flutes 20, and the lower flutes 20 slope downward towards the trough 24 and release the liquids through openings 17 in the front 14a of the base 14, to the trough 24 for collection. Grate stops 18 in the interior of the base 14 support the grate 12 above the flutes 20 and 22. Optional chafing burner rails 26 reside at the bottom of the base 14. Each side 14c of the base 14 has an open bottom gap 15 having a height h0 of preferably about 1.5 cm.

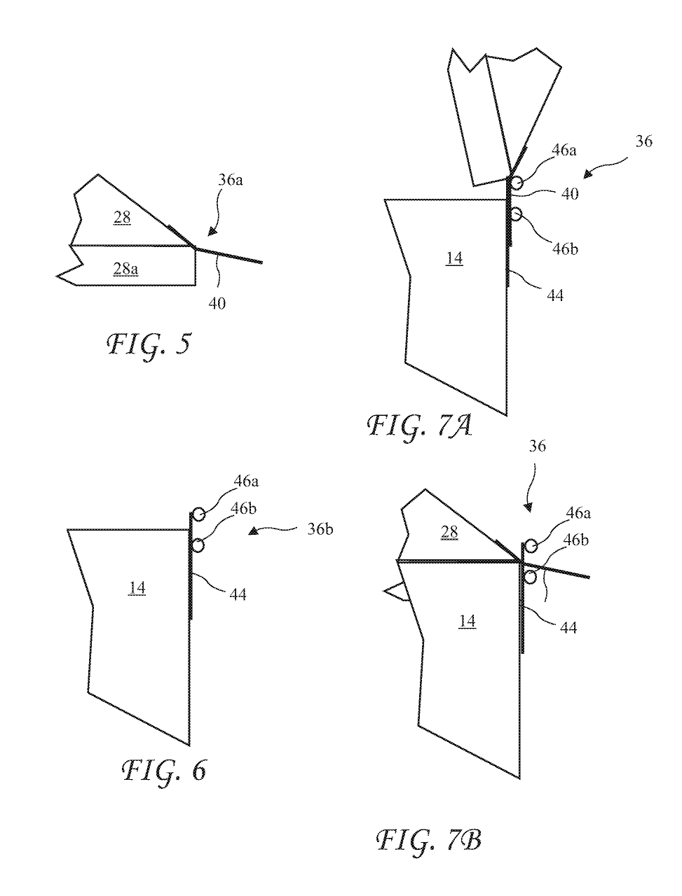

The lid 28 is hingedly attached to the base 14 by operation of a lid catch 36 (see FIGS. 5, 6, 7A, and 7B). The lid 28 pivots closed by the cooperation of a flap 40 attached to the lid 28 with catch portions 36a and 36b attached to the base 14. The lid 28 may be disengaged from the base 14 by lifting which separates the flap 40 from the catch portions 36a and 36b. The lid 28 includes a skirt 28a which slides into the base 14 and the catch 36 and a flap 34 at the front of the lid 28, to limit the depth the lid 28 enters the base 14. The lid 28 further includes skewer notches 16a in sides of the skirt 29 aligned with base skewer notches 16b in the base 14, which may serve as venting.

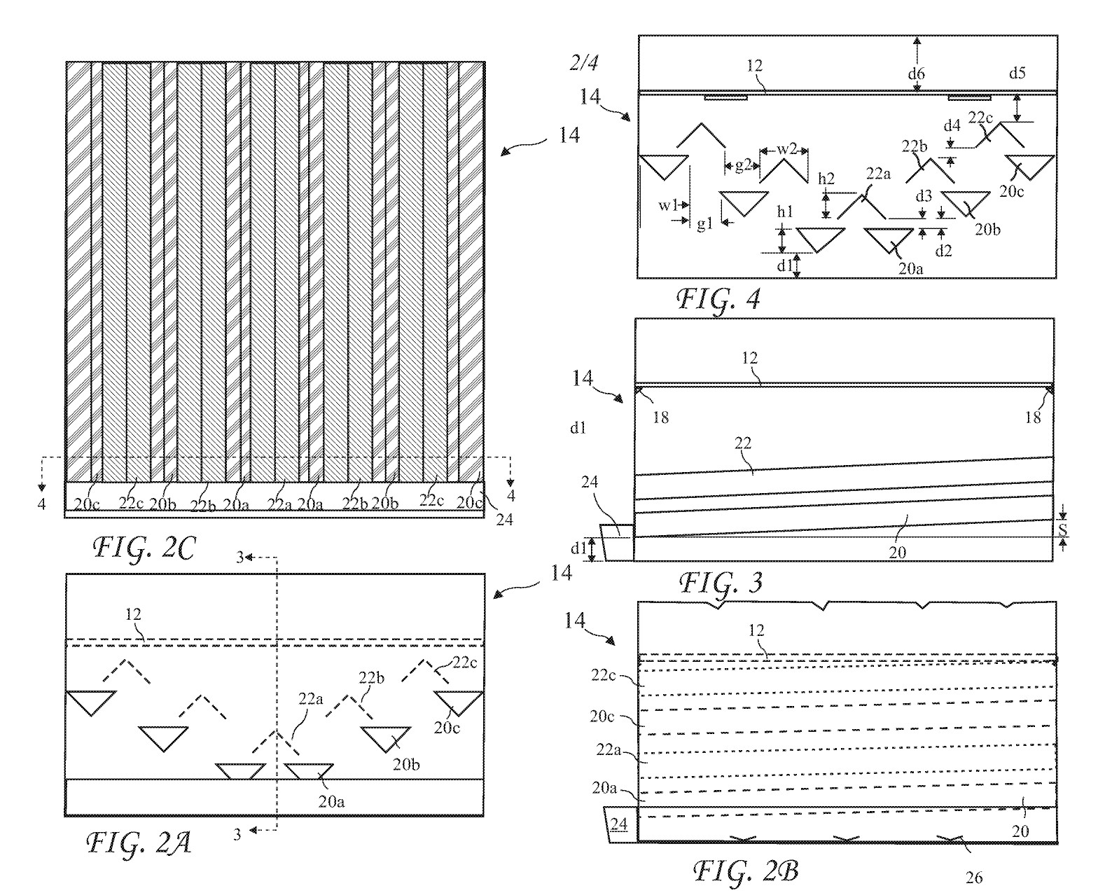

A front view of the base 14 is shown in FIG. 2A, a side view of the base 16 is shown in FIG. 2B, and a top view of the base 14 is shown in FIG. 2C. The lower flutes 20 and inverted upper flutes 22 slope downward a slope S from the rear 14b to the front 14a to the trough 24 to capture liquids released during cooking in the trough 24. The slope S is preferably about 1 cm. The base 14 includes an open bottom 14a to allow flame-grilling. The inverted upper flutes 22a, 22b, and 22c are between and overlap the lower flutes 20a, 20b, and 20c. For clarity, only the inverted upper flutes 22a and 22c, and the lower flutes 20, and 20c are shown in FIG. 2B.

A cross-sectional view of the base 14 taken along line 3-3 of FIG. 2A is shown in FIG. 3. The lower flutes 20a, 20b, and 20c slope down towards the trough 24 a slope S. The front ends of the lower flutes 20a are a distance d1 above the bottom of the base 14. The slope S is preferably about 1 cm and the distance d1 is preferably about 1.5 cm.

A cross-sectional view of the base 14 taken along line 4-4 of FIG. 2C at the front of the base 14, is shown in FIG. 4. The lower flutes 20a, 22b, and 22c have a width w1 and height h1, and are separated by gaps g1, and the inverted upper flutes 22a, 22b, and 22c have a width w2 and height h2, and are separated by gaps g2. The widths w1 and w2 are preferably about 3cm, the heights h1 and h2 are preferably about 1.5 cm, and the gaps g1 and g2 are preferably about 0.8 cm. The lower flutes 20a, 20b, and 20c are vertically spaced apart a distance d2 of preferably about 0.8 cm and the inverted upper flutes 22a, 22b, and 22c are vertically spaced apart a distance d4 of preferably about 0.8 cm. Each of the lower flutes 20a, 20b, and 20c are vertically spaced apart from the inverted upper flutes 22a, 22b, and 22c respectively by preferably about 0.8 cm. The lower flute 20a is vertically spaced the distance d1 above the bottom of the base 14 of preferably about 1.5 cm, and the inverted upper flute 22c is preferably spaced a distance d5 below the grate 12, at the front of the base 14, of preferably about 1 cm. The grate 12 is vertically spaced a distance d6 below the top of the base 14 of preferably about 3.1 cm. The gaps g1 and g2 are preferably about 2 cm.

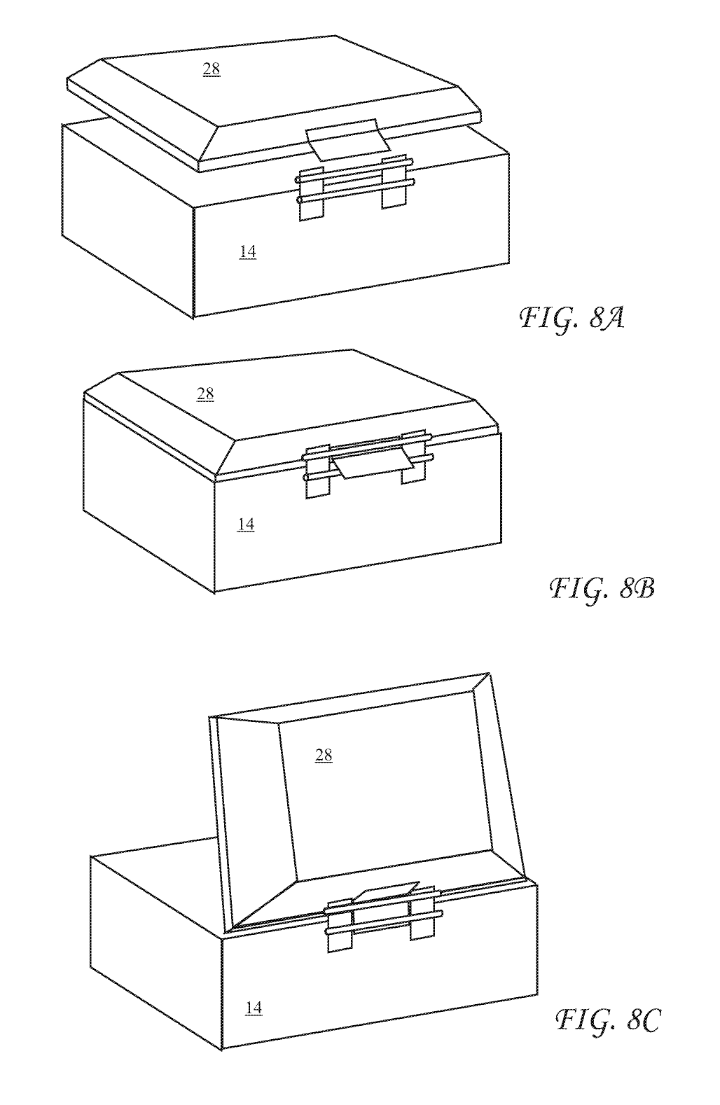

A first catch portion 36a of a catch 36 (see FIGS. 7A and 7B) attached to the rear of the lid 28 is shown in FIG. 5. The first catch portion 36a includes a flap 40 which engages the second catch portion 36b (see FIG. 6) to hold the lid 28 open.

The second catch portion 36b of the catch 36 attached to the base 14 is shown in FIG. 6. The second catch portion 36b includes a fixed strap 44, and vertically spaced apart fixed rods 46a and 46b.

The catch 36 is shown holding the lid 28 open in FIG. 7A. The flap 40 is between the base 14 and both rods 46a and 46b holding the lid 28 in the open position.

The catch 36 is shown with the lid 14 closed in FIG. 7B. The flap 40 reaches between the rods 46a and 46b.

A perspective view of the lid 28 separated from the base 14 of the stove top barbeque 10 is shown in FIG. 8A, a perspective view of the lid 28 closed on the base 14 is shown in FIG. 8B, and a perspective view of the lid 28 held open on the base 14 is shown in FIG. 8C.

While the invention herein disclosed has been described by means of specific embodiments and applications thereof, numerous modifications and variations could be made thereto by those skilled in the art without departing from the scope of the invention set forth in the claims.

1. A stove top barbeque, comprising:
a base including:
a body having a front, a rear, a top, sides, and a bottom;
an open bottom;
lower flutes inside the body opening upward to catch liquids, the lower flutes horizontally spaced apart leaving first gaps between adjacent ones of the lower flutes;
inverted upper flutes inside the body above proximal ones of the lower flutes and overlapping the first gaps between the lower flutes to direct the liquids into the lower flutes;
openings in the front of the body aligned with each of the lower flutes;
a trough at the front having an open top residing under the openings configured to receive the liquids from the lower flutes; and
a grate supported by the base above all of the lower flutes and above all of the inverted upper flutes.

2. The stove top barbeque of claim 1, wherein the lower flutes are sloped down from the rear to the front.

3. The stove top barbeque of claim 2, wherein the lower flutes are sloped down about 1 cm from the rear to the front.

4. The stove top barbeque of claim 2, wherein the inverted upper flutes are sloped down at the same slope as the lower flutes.

5. The stove top barbeque of claim 1, wherein at least one center most one of the lower flutes is lower than the other lower flutes.

6. The stove top barbeque of claim 5, wherein the at least one center most one of the lower flutes comprises two center most lower flutes lower than the other lower flutes.

7. The stove top barbeque of claim 1, wherein the lower flutes are about 3 cm wide.

8. The stove top barbeque of claim 7, wherein the inverted upper flutes have about the same width as the lower flutes.

9. The stove top barbeque of claim 1, wherein the lower flutes are about 1.5 cm high

10. The stove top barbeque of claim 9, wherein the inverted upper flutes have about the same height as the lower flutes.

11. The stove top barbeque of claim 1, wherein the lower flutes are horizontally spaced apart by a gap of about 2 cm.

12. The stove top barbeque of claim 11, wherein the inverted upper flutes horizontally spaced apart about the same gap as the lower flutes.

13. The stove top barbeque of claim 1, wherein the top most of the inverted upper flutes is vertically spaced about 1 cm below the grate at the front of the body.

14. The stove top barbeque of claim 1, wherein the grate is vertically spaced about 3.1 cm below the top of the base.

15. The stove top barbeque of claim 1, wherein the lower flutes comprise six horizontally spaced apart lower flutes.

16. The stove top barbeque of claim 15, wherein the inverted upper flutes comprise five horizontally spaced apart inverted upper flutes.

17. The stove top barbeque of claim 1, wherein the base is about 26 cm wide.

18. The stove top barbeque of claim 1, wherein the body is rectangular and the right and left most lower flutes are in contact with the sides of the body.

19. A stove top barbeque, comprising:
a base including:
a body having a front, a rear, a top, sides, and a bottom;
an open bottom;
a number N of lower flutes inside the body opening upward to catch liquids, the lower flutes horizontally spaced apart leaving first gaps between adjacent ones of the lower flutes, outermost ones of the lower flutes residing against the sides of the body, the lower flutes nearest a center of the body spaced vertically lower than adjacent ones of the lower flutes nearer to the sides of the body;
a number N−1 of inverted upper flutes inside the body above proximal ones of the lower flutes, horizontally spaced apart by second gaps, and overlapping the first gaps between the lower flutes to direct the liquids into the lower flutes;
the lower flutes and the inverted upper flutes sloping down from the rear to the front;
openings in the front of the body aligned with each of the lower flutes;
a trough at the front having an open top residing under the openings configured to receive the liquids from the lower flutes; and
a grate supported by the base above all of the lower flutes and above all of the inverted upper flutes.

20. A stove top barbeque, comprising:
a base including:
a body having a front, a rear, a top, sides, and a bottom;
an open bottom;
six lower flutes inside the body opening upward to catch liquids, the lower flutes horizontally spaced apart leaving first gaps between adjacent ones of the lower flutes, outermost ones of the lower flutes residing against the sides of the body, the lower flutes nearest a center of the body spaced vertically lower than adjacent ones of the lower flutes nearer to the sides of the body;
five inverted upper flutes inside the body above proximal ones of the lower flutes, horizontally spaced apart by second gaps, and overlapping the first gaps between the lower flutes to direct the liquids into the lower flutes;
the lower flutes and the inverted upper flutes having a width of 3 cm and a height of 1.5 cm and sloping down from the rear to the front a slope of 1 cm;
openings in the front of the body aligned with each of the lower flutes;
a trough at the front having an open top residing under the openings configured to receive the liquids from the lower flutes; and
a grate supported by the base above all of the lower flutes and above all of the inverted upper flutes.
